(19) United States
(12) Patent Application Publication
(10) Pub. No.: US 2020/0249703 A1
(43) Pub. Date: Aug. 6, 2020

(54) UNMANNED AERIAL VEHICLE CONTROL METHOD, DEVICE AND SYSTEM

(71) Applicant: SZ DJI TECHNOLOGY CO., LTD., Shenzhen (CN)

(72) Inventors: Yi CHEN, Shenzhen (CN); Ye TAO, Shenzhen (CN)

(21) Appl. No.: 16/843,428

(22) Filed: Apr. 8, 2020

Related U.S. Application Data
(63) Continuation of application No. PCT/CN2017/114041, filed on Nov. 30, 2017.

(51) Int. Cl. G05D 1/12; G05D 1/00; B64C 39/02; G06F 3/0488

(52) U.S. Cl. CPC G05D 1/12; G05D 1/0094; G05D 1/0016; B64C 2201/127; B64C 39/024; G06F 3/0488; B64C 2201/146; G05D 1/0022

(57) ABSTRACT

An unmanned aerial vehicle (UAV) control method includes configuring a target range on an interaction interface for displaying images photographed by a UAV and, in response to detecting a target object being displayed in the target range, controlling the UAV to follow and photograph the target object, such that the target object displayed on the interaction interface remains within the target range continuously.

### CROSS-REFERENCE TO RELATED APPLICATION

This application is a continuation of International Application No. PCT/CN2017/114041, filed on Nov. 30, 2017, the entire content of which is incorporated herein by reference.

### TECHNICAL FIELD

The present disclosure relates to the technical field of unmanned aerial vehicle technology and, more particularly, to an unmanned aerial vehicle control method, a device and a system.

### BACKGROUND

In certain surveillance, search, and photographing tasks for real-world applications, there is a need to detect and follow one or more objects. An unmanned aerial vehicle (UAV) carrying a payload (e.g., a camera) may be used to follow the object. Taking a photographing task as an example, when photographing a movie or other video material, it is necessary to follow a moving target. Thus, a user or a photographer may use the UAV to follow the moving target. Specifically, the moving target is selected first. When the moving target reaches a desired position (e.g., the moving target reaches at a center position of a photographed image), the user manually enters and confirms a follow command. The UAV then follows the moving target according to the follow command. However, this process requires a manual operation by the user. The manual operation inevitably takes some time in the photographing process, in which the moving target may deviate from the desired position in the process of following the moving target. As such, the photographed image may be imperfect, and the video may transition intermittently, and occasional short pauses may occur.

### SUMMARY

In accordance with the disclosure, there is provided an unmanned aerial vehicle (UAV) control method including configuring a target range on an interaction interface for displaying images photographed by a UAV and, in response to detecting a target object being displayed in the target range, controlling the UAV to follow and photograph the target object, such that the target object displayed on the interaction interface remains within the target range continuously.

Also in accordance with the disclosure, there is provided a control terminal including an interaction interface configured to display images photographed by a UAV, and a processor configured to configure a target range on the interaction interface and, in response to detecting a target object being displayed in the target range, control the UAV to follow and photograph the target object, such that the target object displayed on the interaction interface remains within the target range continuously.

Also in accordance with the disclosure, there is provided a UAV control system including a UAV and a control terminal configured to control the UAV. The control terminal includes an interaction interface configured to display images photographed by the UAV, and a processor configured to configure a target range on the interaction interface and, in response to detecting a target object being displayed in the target range, control the UAV to follow and photograph the target object, such that the target object displayed on the interaction interface remains within the target range continuously.

### BRIEF DESCRIPTION OF THE DRAWINGS

To more clearly illustrate the technical solution of the present disclosure, the accompanying drawings used in the description of the disclosed embodiments are briefly described hereinafter. The drawings described below are merely some embodiments of the present disclosure. Other drawings may be derived from such drawings by a person with ordinary skill in the art without creative efforts and may be encompassed in the present disclosure.

FIG. 1 is a schematic architecture diagram of an unmanned aerial vehicle (UAV) system according to an example embodiment of the present disclosure.

FIG. 2 is a flowchart of a UAV control method according to an example embodiment of the present disclosure.

FIG. 3 is a schematic diagram of displaying triggering a composition mode on an interaction interface according to an example embodiment of the present disclosure.

FIG. 4 is a schematic diagram of displaying a target range on the interaction interface according to an example embodiment of the present disclosure.

FIG. 5 is a schematic diagram of displaying a target object in the target range on the interaction interface according to an example embodiment of the present disclosure.

FIG. 6 is a structural block diagram of a control terminal according to an example embodiment of the present disclosure.

FIG. 7 is a structural block diagram of a UAV control system according to an example embodiment of the present disclosure.

### DETAILED DESCRIPTION OF THE EMBODIMENTS

Embodiments of the present disclosure are described in detail below with reference to the accompanying drawings. Same or similar reference numerals in the drawings represent the same or similar elements or elements having the same or similar functions throughout the specification. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

The present disclosure provides an unmanned aerial vehicle (UAV) control method, a device, and a system. The UAV may be a rotorcraft, for example, a multi-rotor aircraft propelled by a plurality of propulsion devices through air. However, the embodiments of the present disclosure are not limited thereto.

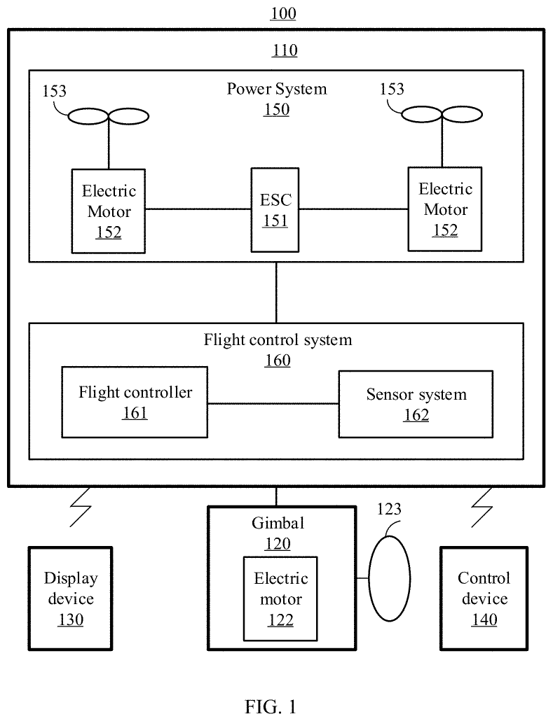

FIG. 1 is a schematic architecture diagram of an unmanned aerial vehicle (UAV) system 100 according to an example embodiment of the present disclosure. The rotor propelled UAV is used for illustration.

The UAV system 100 includes a UAV 110, a gimbal 120, a display device 130, and a control device 140. The UAV 110 includes a power system 150, a flight control system 160, and a vehicle frame. The UAV 110 wirelessly communicates with the control device 140 and the display device 130.

The vehicle frame includes a vehicle body and a plurality stands (also known as landing gear). The body include a center frame and one or more arms connected to the center frame. The one or more arms extend radially from the center frame. The plurality of stands are connected to the body to support the UAV 110 when landing.

The power system 150 includes one or more electronic speed controllers 151 (referred to as ESC), one or more propellers 153, and one or more electric motors 152 corresponding to the one or more propellers 153. The electric motor 152 connects between the ESC 151 and the propeller 153. The electric motor 152 and the propeller 153 are disposed at the arm of the UAV 110. The ESC 151 receives a driving signal generated by the flight control system 160 and supplies a driving current to the electric motor 152 based on the driving signal to control a rotation speed of the electric motor 152. The electric motor 152 drives the propeller to rotate, thereby supplying power for the flight of the UAV 110. The power enables the UAV 110 to move in one ore more degrees of freedom. In some embodiments, the UAV 110 may rotate around one or more rotation axes. For example, the rotation axes include a roll axis, a yaw axis, and a pitch axis. The electric motor 152 may be a direct current (DC) motor or an alternate current (AC) motor. In addition, the electric motor 152 may be a brushless motor or a brushed motor.

The flight control system 160 includes a flight controller 161 and a sensing system 162. The sensing system 162 measures attitude information of the UAV, that is, spatial position information and status information of the UAV 110, such as three-dimensional position, three-dimensional angle, three-dimensional velocity, three-dimensional acceleration, and three-dimensional angular velocity. The sensing system 162 may include, for example, at least one of a gyroscope, an ultrasonic sensor, an electronic compass, an inertial measurement unit (IMU), a visual sensor, a global navigation satellite system, or a barometer. For example, the global navigation satellite system is the Global Positioning System (GPS). The flight controller 161 controls the flight of the UAV 110, and for example, controls the flight of the UAV 110 based on the attitude information measured by the sensing system 162. The flight controller 161 may control the UAV 110 according to pre-programmed program instructions or may control the UAV 110 in response to one or more control instructions from the control device 140.

The gimbal 120 includes an electric motor 122. The gimbal carries a photographing device 123. The flight controller 161 controls movement of the gimbal 120 through the electric motor 122. In some embodiments, the gimbal 120 also includes a controller for controlling the movement of the gimbal 120 through controlling the electric motor 122. The gimbal 120 may be independent of the UAV 110 or may be a part of the UAV 110. The electric motor 122 may be a DC motor or an AC motor. In addition, the electric motor 122 may be a brushless motor or a brushed motor. The gimbal 120 may be located at the top of the UAV 110 or at the bottom of the UAV 110.

The photographing device 123 may be, for example, a device for capturing an image, such as a camera or a video camcorder. The photographing device 123 communicates with the flight controller 161 and takes photographs under the control of the flight controller 161. The photographing device 123 includes at least a photosensitive element. The photosensitive element may be, for example, a complementary metal oxide semiconductor (CMOS) sensor or a charge-coupled device (CCD) sensor.

The display device 130 is located at a ground terminal of the UAV system 100, wirelessly communicates with the UAV 110, and displays the attitude information of the UAV 110. In addition, the display device 130 also displays images captured by the photographing device 123. The display device 130 may be an independent device or may be integrated in the control device 140.

The control device 140 is located at the ground terminal of the UAV system 100, wirelessly communicates with the UAV 110, and remotely controls the UAV 110.

It should be understood that the foregoing naming of each part of the UAV system 100 is for identification purpose only, and should not be construed as limiting the embodiments of the present disclosure.

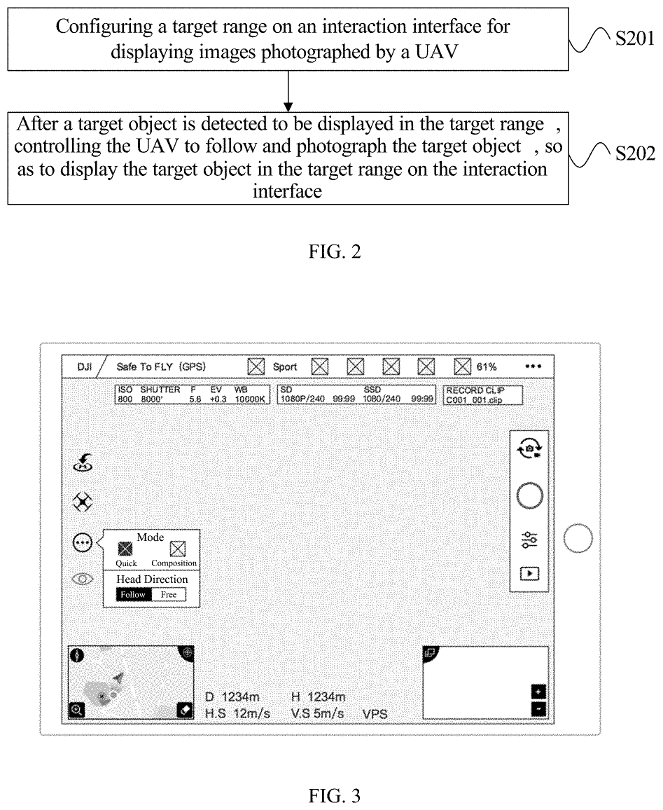

FIG. 2 is a flowchart of a UAV control method according to an example embodiment of the present disclosure. As shown in FIG. 2, the method includes the following.

At S201, a target range is configured on an interaction interface for displaying images photographed by a UAV.

The interaction interface is an important part of a control terminal. The interaction interface facilitates interaction with a user. The control terminal may be, for example, a smart phone, or a tablet computer, etc. The user performs operations on the interaction interface to control the UAV and at the same time, displays all parameters of the UAV and the images captured by the UAV. When the user intends to control the UAV, the user performs an operation on the interaction interface. In some embodiments, a range is configured on the interaction interface. The configured range is referred to as the target range. The target range may be, for example, located at the center of the interaction interface. The UAV carries the photographing device, such as the camera. The UAV captures the images through the photographing device. The interaction interface displays the images captured by the UAV.

At S202, after a target object is detected to be displayed in the target range, the UAV is controlled to follow and photograph the target object, so as to display the target object in the target range on the interaction interface.

In some embodiments, after the target range is configured on the interaction interface, whether any target object is displayed in the target range is detected. The target object is detected to be displayed in the target range when an image of the target object is displayed on the interaction interface and the target object is displayed in the target range on the interaction interface. For example, the target range is at the center position. When it is detected that the target object is displayed at the center position of the interaction interface, the UAV is controlled to follow and photograph the target object. In the photographing process, the target object in the images photographed by the UAV appears in the target range on the interaction interface continuously.

The target object may be the first object that enters the target range after the target range is configured. The target object may be the object that is in the target range and is closest to the UAV after the target interface is configured. An object type may be pre-configured for the target object. The target object may be the object that matches the object type pre-configured for the target object. For example, the pre-configured object type may be an automobile, a human, or an animal, etc.

In some embodiments, the target range is configured on the interaction interface. When it is detected that the target object is displayed in the target range, the UAV is controlled to follow and photograph the target object, so as to display the target object in the target range on the interaction interface. As such, the UAV automatically follows and photographs the target object. No matter how the target object moves, the target object photographed by the UAV always appears in the target range on the interaction interface. Magnificent images may be captured without the manual operation by the user to select and follow the target object. Thus, the captured images look smooth and the efficiency of following the target object is also improved.

In some embodiments, S201 may include detecting a first operation on the interaction interface and configuring the target range on the interaction interface based on the first operation.

In some embodiments, the user performs the operation on the interaction interface to configure the target range on the interaction interface. When the user is performing the operation on the interaction interface, the operation by the user on the interaction interface is detected. In some embodiments, when the user intends to configure the target range on the interaction interface, the user performs the first operation on the interaction interface. The interaction interface detects the first operation. The control terminal may be the foregoing control device 140 and details are not described herein again.

The user performs the first operation on the interaction interface. The first operation triggers configuring the target range. After the interaction interface detects the first operation, the control terminal determines the target range corresponding to the detected first operation and configures the target range on the interaction interface.

In some embodiments, when the first operation is an image frame operation, configuring the target range on the interaction interface based on the first operation may include configuring a range on the interaction interface selected by the image frame operation as the target range.

The interaction interface may detect a contact of the user's finger on the interaction interface. When the operation is the image frame operation, e.g., when the user's finger touches or presses on the interaction interface displaying the photographed image and drags while keeping touching or pressing on the interaction interface to form a rectangle shape on the interaction interface, the UAV determines the range selected by the rectangular shape to be the target range. The rectangular shape is intended to be illustrative. However, the shape of the image frame is not limited by the present disclosure. For example, the image frame may be a circle. It is convenient for the user to perform the image frame operation precisely to obtain the desired target range.

In some embodiments, when the first operation is a point touch operation, configuring the target range on the interaction interface based on the first operation may include obtaining a pressure applied on the interaction interface by the corresponding point touch operation, and based on the touch position and the pressure of the point touch operation, configuring the target range on the interaction interface. The pressure determines a size of the target range.

The interaction interface detects the press or touch by the user's finger on the interaction interface. The operation is the point touch operation when the user's finger presses or touches on the interaction interface displaying the photographed images and the interaction interface detects the touch point. The touch point may be treated as a center point or a terminal point of the target range. The interaction interface also detects the pressure applied on the interaction interface by the user's finger and determines the size of the target range based on the pressure. For example, to increase the size of the target range, the user may press harder on the touch point. To decrease the size the target range, the user may press softer on the touch point. In addition, the size of the target range may be determined by a clicking mode of the point touch operation. For example, a double-click defines a target range with a first size and a single-click defines a target range with a second size. When the user's finger is removed from the touch point, the size of the target range is determined. The point touch operation with variable touch pressure may improve the accuracy of configuring the target range and simplify the operation.

In some embodiments, when the first operation is the point touch operation, configuring the target range on the interaction interface based on the first operation may include obtaining the touch point corresponding to the point touch operation, and based on the touch point corresponding to the point touch operation and a pre-set size of the target range, configuring the target range on the interaction interface.

The interaction interface detects the press or touch by the user's finger on the interaction interface. The operation is the point touch operation when the user's finger presses or touches on the interaction interface displaying the photographed images and the interaction interface detects the touch point. The touch point may be treated as a center point or a terminal point of the target range. The size of the target range is pre-set. As such, the target range is determined. In this case, the size of the target range is fixed and is not adjustable. However, the position of the target range is determined by the point touch operation.

In some embodiments, S201 may include obtaining an inputted setting command including position information of the target range on the interaction interface and configuring the target range on the interaction interface based on the position information.

In some embodiments, configuring the target range is achieved through entering a command. For example, the interaction interface displays options of the to-be-determined target ranges. The user enters the position information of the target range on the interaction interface into the options through a keyboard (e.g., a virtual keyboard or a physical keyboard). In some embodiments, the options include a plurality of pieces of to-be-selected position information and the user selects one piece of position information from the plurality of pieces of to-be-selected position information. For example, the position information may be coordinates in a UOV coordinate system on the interaction interface. When the user confirms to submit the position information, the control terminal receives the setting command. Because the setting command includes the position information, the target range may be configured on the interaction interface based on the setting command.

In some embodiments, after configuring the target range on the interaction interface, the control terminal may further display an identifier indicating the target range on the interaction interface. For example, the first operation is the image frame operation and the shape of the image frame operation is a rectangular. The rectangular frame of the target range is used as the identifier to indicate the target range. For example, the identifier is displayed when the rectangular frame is highlighted on the interaction interface.

In some embodiments, controlling the UAV to follow and photograph the target object at S202 includes controlling the UAV to fly to follow the target object while photographing the target object. In some embodiments, as the target object moves, the UAV is controlled to fly to follow. For example, a constant distance between the UAV and the target object is maintained to control the UAV to fly to follow the target object while photographing the target object. Because the distance between the UAV and the target object is fixed, the target object is always displayed in the target range on the interaction interface and the image clarity remains relatively fixed.

In some embodiments, controlling the UAV to follow and photograph the target object at S202 includes controlling a camera mounted at the UAV to rotate to follow the target object while photographing the target object. In some embodiments, the UAV remains at the same current position. As the target object moves, a relative angle between the target object and the UAV changes, causing the target object displayed on the interaction interface to deviate from the target range. To ensure that the target object displayed on the interaction interface always remains within the target range, as the target object moves, the UAV is controlled to rotate to follow. For example, a constant angle between the UAV and the target object is maintained to control the UAV to rotate to follow the target object while photographing the target object. In some other embodiments, the target object remains at the same current position while the UAV continues to fly. The flight of the UAV may cause the relative angle between the target object and the UAV to change, thereby causing the target object displayed on the interaction interface to deviate from the target range. To ensure that the target object displayed on the interaction interface always remains within the target range, the UAV is controlled to rotate to follow. For example, a constant angle between the UAV and the target object is maintained to control the UAV to rotate to follow the target object while photographing the target object. Because the relative angle between the UAV and the target object is fixed, the target object is always displayed in the target range on the interaction interface. Controlling the UAV to rotate includes controlling the gimbal carrying the photographing device to rotate.

In some embodiments, before S202 is performed, query prompt information is outputted (e.g., displayed) on the interaction interface. The query prompt information prompts the user to confirm to enter into a follow mode. The interaction interface obtains query response information. The query response information indicates whether the user confirms or refuses to enter into the follow mode. Thus, after the target range is configured on the interaction interface, the user obtains the query prompt information on the interaction interface, which prompts the user to decide whether to enter into the follow mode automatically after the target range is configured. When the user determines whether to enter into the follow mode, the user inputs the query response information on the interaction interface. The control terminal obtains the query response information through the interaction interface. When the user chooses to enter into the follow mode, and for example, “Yes” and “No” are displayed on the interaction interface, the user chooses “Yes.” Correspondingly, the control terminal obtains the query response information indicating confirmation of entering into the follow mode, and then performs S202. When the user chooses not to enter into the follow mode, and for example, “Yes” and “No” are displayed on the interaction interface, the user chooses “No.” Correspondingly, the control terminal obtains the query response information indicating refusal of entering into the follow mode, and then does not perform S202.

In some embodiments, after S202 is performed, if the user believes the configured target range is not what the user wants or the user wants to modify the target range, the target range can be adjusted. For example, at least one of the size, the shape, or the position of the target range can be adjusted. When S202 is performed, and the target object is detected to be displayed within the adjusted target range, the UAV is controlled to follow and photograph the target object.

In some embodiments, before S201 is performed, the control terminal needs to enter into a target range setting mode. The target range setting mode is also referred to as a composition mode. The user may perform an operation on the interaction interface to enter into the composition mode. Correspondingly, the interaction interface detects a second operation. The second operation triggers a first instruction. Based on the second operation, the first instruction is obtained. The first instruction triggers the composition mode. Based on the first instruction, the composition mode is triggered, that is, entering into the composition mode. Then, based on the composition mode, the target range is configured on the interaction interface. For example, as shown in FIG. 3, when the user performs the operation of clicking a “composition” icon (i.e., the second operation), the first instruction is obtained.

In some embodiments, after the composition mode is triggered, when the user does not want to enter into the composition mode, the user may perform the operation on the interaction interface to cancel the composition mode. Correspondingly, the interaction interfaces detects a third operation. The third operation triggers a second instruction. Based on the third operation, the second instruction is obtained. The second instruction cancels the composition mode. Based on the second instruction, the composition mode is canceled. For example, as shown in FIG. 3, when the user performs the operation of clicking a “quick” icon (i.e., the third operation), the second instruction is obtained.

In some embodiments, when the user no longer wants the UAV to follow and photograph the target object, the user performs the operation on the interaction interface to stop following the target object. Correspondingly, the interaction interface detects a fourth operation. The fourth operation triggers a third instruction. Based on the fourth operation, the third instruction is obtained. The third instruction cancels following the target object. Based on the third instruction, the UAV is controlled to stop following the target object.

The examples displayed on the interaction interface are described in detail below.

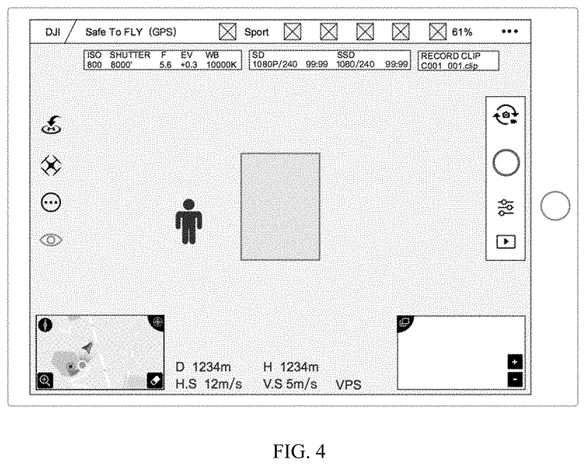

For example, as shown in FIG. 3, the user selects the “composition” icon to trigger the composition mode. In the composition mode, the user performs the operation on the interaction interface to configure the target range. For example, as shown in FIG. 4, the rectangular frame indicating the target range is displayed at the center position of the interaction interface. For example, the target object is a person. As shown in FIG. 4, the person displayed on the interaction interface is away from the target range by a certain distance. When the person and/or the UAV moves, the distance between the person displayed on the interaction interface and the target range changes. When the person displayed on the interaction interface enters into the target range, as shown in FIG. 5, the target object is detected to be displayed in the target range. The UAV is controlled to follow and photograph the target object. At this time, the relative position between the person displayed on the interaction interface and the target range remains unchanged as shown in FIG. 5. In some embodiments, after the UAV follows and photographs the target object, to remind the user that the UAV is following the target object, a display color of the rectangular frame indicating the target range changes from a first color to a second color.

The present disclosure also provides a computer-readable storage medium. The computer-readable storage medium stores program instructions. When being executed, the program instructions implement some or all processes of the UAV control method consistent with the disclosure, such as one of the example methods described above, e.g., in the method described in connection with FIG. 2.

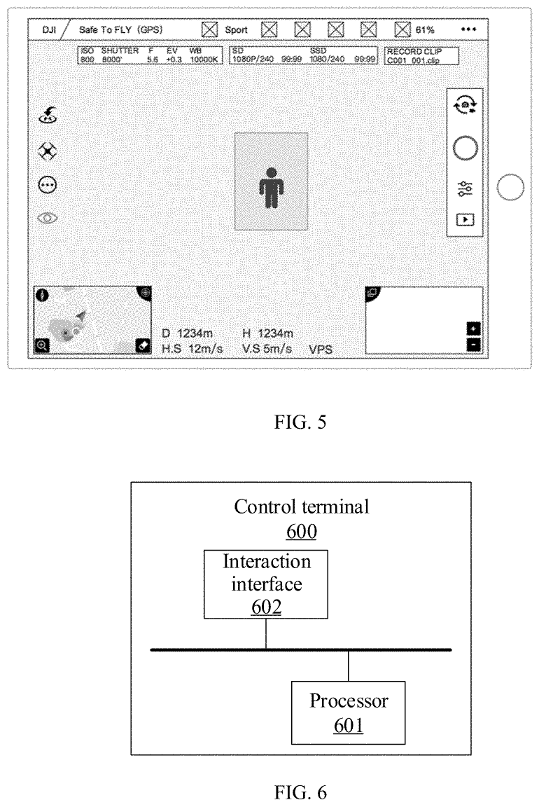

FIG. 6 is a structural block diagram of a control terminal according to an example embodiment of the present disclosure. As shown in FIG. 6, the control terminal 600 includes a processor 601 and an interaction interface 602. The interaction interface is an operation interface displayed on a touch-control display.

The processor 601 may be a central processing unit (CPU). The processor 601 may also be a general-purpose processor, a digital signal processor (DSP), an application specific integrate circuit (ASIC), a field-programmable gate array (FPGA), other programmable logic devices, discrete gates, transistor logic devices, or discrete hardware assemblies. The general-purpose processor may be a microprocessor or any conventional processor,

The processor 601 is configured to configure the target range on the interaction interface 602. The interaction interface displays images captured by the UAV. When the target object is detected to be displayed in the target range, the UAV is controlled to follow and photograph the target object, so as to display the target object in the target range on the interaction interface.

In some embodiments, the interaction interface 602 detects the first operation. The processor 601 is configured to configure the target range on the interaction interface 602 based on the first operation detected on the interaction interface.

In some embodiments, the first operation is the image frame operation. The processor 601 is configured to configure a range on the interaction interface 602 defined by the image frame operation as the target range.

In some embodiments, the first operation is the point touch operation. The processor 601 is configured to obtain a pressure applied to the interaction interface by a touch point corresponding to the point touch operation, and based on the touch point and the pressure corresponding to the point touch operation, configure the target range on the interaction interface 602. The pressure adjusts the size of the target range. In addition, the size of the target range may be determined by a clicking mode of the point touch operation. For example, a double-click defines a target range with a first size and a single-click defines a target range with a second size.

In some embodiments, the processor 601 is further configured to obtain an inputted setting command including position information of the target range on the interaction interface, and based on the position information, configure the target range on the interaction interface 602.

In some embodiments, the processor 601 is further configured to control the UAV to fly to follow the target object while photographing the target object or control the camera mounted at the UAV to rotate to follow the target object while photographing the target object.

In some embodiments, the processor 601 is further configured to output the query prompt information on the interaction interface 602 before controlling the UAV to follow and photograph the target object, and obtain the query response information through the interaction interface 602. The query prompt information prompts the user to confirm to enter into the follow mode. The query response information indicates whether the user confirms or refuses to enter into the follow mode. When controlling the UAV to follow and photograph the target object, the processor 601 is further configured to, when the query response information indicates the confirmation of entering into the follow mode, control the UAV to follow and photograph the target object.

In some embodiments, the processor 601 is further configured to, after the target range is configured on the interaction interface 602, adjust at least one of the size, the shape, or the position of the target range.

When the target object is detected to be displayed in the target range and the UAV is controlled to follow and photograph the target object, the processor 601 is further configured to, when the target object is detected to be displayed in the target range, control the UAV to fly to follow the target object while photographing the target object.

In some embodiments, the interaction interface 602 is further configured to detect the second operation before the processor 601 configures the target range on the interaction interface 602. The processor 601 is further configured to: based on the second operation detected by the interaction interface 602, obtain the first instruction for triggering the composition mode. When configuring the target range on the interaction interface 602, the processor 601 is further configured to, based on the composition mode, configure the target range on the interaction interface 602.

In some embodiments, the interaction interface 602 is further configured to detect the third operation. The processor 601 is further configured to: based on the third operation detected by the interaction interface 502, obtain the second instruction for cancelling the composition mode, and based on the second instruction, cancel the target range on the interaction interface 602.

In some embodiments, the interaction interface 602 is further configured to detect the fourth operation. The processor 601 is further configured to, based on the fourth operation detected by the interaction interface 502, obtain the third instruction for stop following the target object, and based on the third instruction, control the UAV to stop following the target object.

In some embodiments, the interaction interface 602 is further configured to, after the processor 601 configures the target range on the interaction interface 602, display the identifier indicating the target range.

In some embodiments, the control terminal may also include a memory, not shown in the drawing. The processor 601, the interaction interface 602, and the memory are connected through a bus. The memory may include a read-only memory (ROM) and/or a random-access memory (RAM) to supply instructions and data to the processor 601. A part of the memory may include a non-volatile random-access memory. The memory stores codes implementing the UAV control method. The processor 601 invokes the codes stored in the memory to implement the foregoing solutions.

The present disclosure also provides a device for controlling the UAV. The device also implements the technical solutions in the method embodiments. The device has the operation principle and the technical effect similar to the UAV control method, and details are not described herein again.

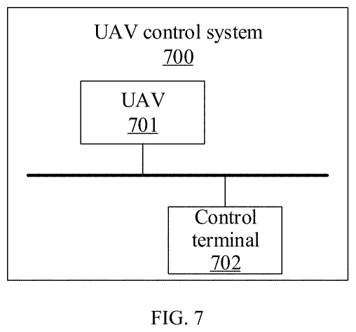

FIG. 7 is a structural block diagram of a UAV control system according to an example embodiment of the present disclosure. As shown in FIG. 7, the UAV control system 700 includes a UAV 701 and a control terminal 702. The control terminal 702 controls the UAV 701. The control terminal 702 may adopt the structure shown in FIG. 6 and correspondingly, implements the technical solutions in the method embodiments. The control terminal 702 has the operation principle and the technical effect similar to the UAV control method, and details are not described herein again.

Those of ordinary skill in the art may understand that all or some part of the processes of implementing the foregoing method embodiments may be completed by a program instructing related hardware. The program may be stored in the computer-readable storage medium. When being executed, the program implements the method embodiments. The computer-readable storage medium includes, but is not limited to, various media for storing the program codes, such as a read-only memory (ROM), a random-access memory (RAM), a magnetic disk, and an optical disk.

Various embodiments of the present disclosure are merely used to illustrate the technical solution of the present disclosure, but the scope of the present disclosure is not limited thereto. Although the present disclosure has been described in detail with reference to the foregoing embodiments, those skilled in the art should understand that the technical solution described in the foregoing embodiments can still be modified or some or all technical features can be equivalently replaced. Without departing from the spirit and principles of the present disclosure, any modifications, equivalent substitutions, and improvements, etc. shall fall within the scope of the present disclosure. Thus, the scope of invention should be determined by the appended claims.

What is claimed is:

1. An unmanned aerial vehicle (UAV) control method comprising:
configuring a target range on an interaction interface for displaying images photographed by a UAV; and
in response to detecting a target object being displayed in the target range, controlling the UAV to follow and photograph the target object, such that the target object displayed on the interaction interface remains within the target range continuously.

2. The method of claim 1, wherein configuring the target range on the interaction interface includes:
detecting an operation on the interaction interface; and
based on the first operation, configuring the target range on the interaction interface.

3. The method of claim 2, wherein:
the operation includes an image frame operation; and
configuring the target range on the interaction interface based on the operation includes configuring a range on the interaction interface selected by the image frame operation as the target range.

4. The method of claim 2, wherein:
the operation includes a point touch operation; and
configuring the target range on the interaction interface based on the operation includes:
obtaining a touch point corresponding to the point touch operation and a pressure applied to the interaction interface by the point touch operation; and
based on the touch point and the pressure, configuring the target range on the interaction interface, a size of the target range depending on the pressure or a clicking mode of the point touch operation.

5. The method of claim 1, wherein configuring the target range on the interaction interface includes:
obtaining an inputted setting command including position information of the target range on the interaction interface; and
based on the position information, configuring the target range on the interaction interface.

6. The method of claim 1, wherein controlling the UAV to follow and photograph the target object includes:
controlling the UAV to fly to follow the target object while photographing the target object; or
controlling a camera mounted at the UAV to rotate to follow the target object while photographing the target object.

7. The method of claim 1, further comprising, before controlling the UAV to follow and photograph the target object:
outputting query prompt information on the interaction interface, the query prompt information prompting a user to confirm to enter a follow mode; and
obtaining query response information through the interaction interface, the query response information indicating whether the user confirms or refuses to enter the follow mode;
wherein controlling the UAV to follow and photograph the target object includes, in response to the query response information indicating confirmation of entering the follow mode, controlling the UAV to follow and photograph the target object.

8. The method of claim 1, further comprising, after configuring the target range on the interaction interface:
adjusting at least one of a size, a shape, or a position of the target range to obtain an adjusted target range;
wherein in response to detecting the target object being displayed in the target range, controlling the UAV to follow and photograph the target object includes, in response to detecting the target object being displayed in the adjusted target range, controlling the UAV to follow and photograph the target object.

9. The method of claim 1, further comprising, before configuring the target range on the interaction interface:
detecting an operation on the interaction interface; and
based on the operation, obtaining an instruction for triggering a composition mode;
wherein configuring the target range on the interaction interface includes, based on the composition mode, configuring the target range on the interaction interface.

10. The method of claim 9,
wherein the operation is a first operation and the instruction is a first instruction;
the method further comprising:
detecting a second operation on the interaction interface;
based on the second operation, obtaining a second instruction for cancelling the composition mode; and
based on the second instruction, cancelling the target range on the interaction interface.

11. A control terminal comprising:
an interaction interface configured to display images photographed by an unmanned aerial vehicle (UAV); and
a processor configured to:
configure a target range on the interaction interface; and
in response to detecting a target object being displayed in the target range, control the UAV to follow and photograph the target object, such that the target object displayed on the interaction interface remains within the target range continuously.

12. The control terminal of claim 11, wherein:
the interaction interface is further configured to detect an operation; and
the processor is further configured to, based on the first operation, configure the target range on the interaction interface.

13. The control terminal of claim 12, wherein:
the operation includes an image frame operation; and
the processor is further configured to configure a range on the interaction interface selected by the image frame operation as the target range.

14. The control terminal of claim 12, wherein:
the operation includes a point touch operation; and
the processor is further configured to:
obtain a touch point corresponding to the point touch operation and a pressure applied to the interaction interface by the point touch operation; and
based on the touch point and the pressure, configure the target range on the interaction interface, a size of the target range depending on the pressure or a clicking mode of the point touch operation.

15. The control terminal of claim 11, wherein the processor is further configured to:
obtain an inputted setting command including position information of the target range on the interaction interface; and
based on the position information, configure the target range on the interaction interface.

16. The control terminal of claim 11, wherein the processor is further configured to:
control the UAV to fly to follow the target object while photographing the target object; or
control a camera mounted at the UAV to rotate to follow the target object while photographing the target object.

17. The control terminal of claim 11, wherein the processor is further configured to:
before controlling the UAV to follow and photograph the target object:
output query prompt information on the interaction interface, the query prompt information prompting a user to confirm to enter a follow mode; and
obtain query response information through the interaction interface, the query response information indicating whether the user confirms or refuses to enter the follow mode; and
in response to the query response information indicating confirmation of entering the follow mode, control the UAV to follow and photograph the target object.

18. The control terminal of claim 11, wherein the processor is further configured to:
after configuring the target range on the interaction interface, adjust at least one of a size, a shape, or a position of the target range to obtain an adjusted target range; and
in response to detecting the target object being displayed in the adjusted target range, control the UAV to follow and photograph the target object.

19. The control terminal of claim 11, wherein:
the interaction interface is further configured to detect an operation; and
the processor is further configured to:
based on the operation, obtain an instruction for triggering a composition mode; and
based on the composition mode, configure the target range on the interaction interface.

20. An unmanned aerial vehicle (UAV) control system comprising:
a UAV; and
a control terminal configured to control the UAV and including:
an interaction interface configured to display images photographed by the UAV; and
a processor configured to:
configure a target range on the interaction interface; and
in response to detecting a target object being displayed in the target range, control the UAV to follow and photograph the target object, such that the target object displayed on the interaction interface remains within the target range continuously.
